(19) United States
(12) Patent Application Publication
(10) Pub. No.: US 2006/0179299 A1
(43) Pub. Date: Aug. 10, 2006

(54) E-mail communication device

(75) Inventors: Yoshifumi Tanimoto, Hirakata-shi (JP); Kazuo Soumiya, Kyoto-shi (JP); Shigeki Takeuchi, Otsu-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/291,214

(22) Filed: Nov. 30, 2005

(30) Foreign Application Priority Data
Feb. 8, 2005 (JP) 2005-031798
Feb. 8, 2005 (JP) 2005-031794

(51) Int. Cl. H04L 9/00

(52) U.S. Cl. 713/158

(57) ABSTRACT

The present invention provides a highly reliable e-mail communication device capable of monitoring validity of a certificate of the e-mail communication device itself. The e-mail communication device includes a certificate storage unit which stores a certificate of the e-mail communication device itself, a signature unit which adds a digital signature to e-mail by using the certificate, a transmission unit which transmits the e-mail, and a monitor unit which monitors validity of the certificate.

### BACKGROUND OF THE INVENTION

1. Field of the Invention

The present invention relates to an e-mail communication device. In particular, the present invention relates to an e-mail communication device capable of adding a digital signature (electronic signature) to electronic mail (hereinafter “e-mail”) and transmitting the e-mail.

2. Description of the Related Art

To prevent falsification or spoofing of e-mail, a recent e-mail communication device adds a digital signature to e-mail by using a certificate issued from a trustable certificate authority and transmits the e-mail. When a public key of the e-mail communication device is newly registered or updated, another party of communication using the public key can easily acquire the new public key.

The certificate registered in the e-mail communication device has an effective period. Therefore, to prevent an expired certificate from being used, a user is required to manage the certificate. Thus, the e-mail communication device lacked convenience. When an expired certificate is used by mistake, reliability of the e-mail communication device decreases. There exists room for improvement.

### SUMMARY OF THE INVENTION

In order to overcome the problems described above, an advantage of the present invention is to provide a highly reliable e-mail communication device capable of periodically monitoring validity of a certificate of the e-mail communication device.

Another advantage of the present invention is to provide a highly reliable e-mail communication device capable of detecting an expiration of a certificate of the e-mail communication device and controlling transmission of the e-mail.

According to an aspect of the present invention, an e-mail communication device includes a storage unit, a signature unit, a transmission unit and a monitor unit. The storage unit stores a certificate of the e-mail communication device itself. The signature unit adds a digital signature to e-mail by using the certificate. The transmission unit transmits the e-mail. The monitor unit monitors validity of the certificate.

For example, the validity of the certificate is whether or not an effective period of the certificate has expired, whether or not a remaining number of days of the effective period is a prescribed warning number of days or less, or whether or not the certificate has not become invalid. The monitor unit monitors periodically, at a prescribed time, or as appropriate according to a request from a user.

According to the above-described aspect, the validity of the certificate of the e-mail communication device can be monitored periodically. As a result, a management of the certificate can be facilitated, and reliability of e-mail improves.

According to another aspect of the present invention, the e-mail communication device further includes a notification unit which notifies the user when the monitor unit determines that the certificate is invalid. The notification unit displays a message on a display unit or outputs the message by voice from a voice output unit. Alternatively, the notification unit transmits e-mail including the message to a prescribed e-mail account. For example, the message is “Effective period of certificate has expired”, “Effective period of certificate will expire shortly” or “Certificate is invalid”.

According to the above-described aspect, when the certificate of the e-mail communication device is invalid, the user is notified. As a result, a highly reliable e-mail communication device is provided.

According to another aspect of the present invention, the e-mail communication device includes an update accepting unit and an updating unit. The update accepting unit accepts a new certificate. The updating unit stores the new certificate accepted by the update accepting unit into the storage unit and updates the certificate.

In the above-described e-mail communication device, when the monitor unit determines that the certificate is invalid, until the updating unit updates the certificate, the transmission unit can suspend the transmission of the e-mail. According to the above-described aspect, e-mail is not transmitted by using an invalid certificate, and e-mail can be transmitted by attaching a valid certificate. As a result, reliability of e-mail improves.

In the above-described e-mail communication device, when the monitor unit determines that the certificate is invalid, the transmission unit can transmit the e-mail without the digital signature. According to this aspect, e-mail is not transmitted by using an invalid certificate. As a result, reliability of e-mail improves.

According to another aspect of the present invention, an e-mail communication device includes a storage unit, a signature unit, a transmission unit, an accepting unit, a detecting unit and a control unit. The storage unit stores a certificate of the e-mail communication device including an effective period. The signature unit adds a digital signature to e-mail by using the certificate. The transmission unit transmits the e-mail. The accepting unit accepts a transmission instruction of the e-mail. The detecting unit detects an expiration of the effective period of the certificate when the accepting unit accepts the transmission instruction. The control unit controls the transmission unit when the detecting unit detects the expiration of the certificate.

The certificate of the e-mail communication device is a certificate issued from a trustable certificate authority used for the digital signature. The certificate includes the effective period. According to this aspect, the e-mail can be transmitted after confirming validity of the certificate of the e-mail communication device. As a result, reliability of e-mail improves.

According to another aspect of the present invention, the e-mail communication device includes a notification unit which notifies the user when the detecting unit detects the expiration of the certificate. The notification unit can display a message, such as “Effective period of certificate has expired” on a display unit, or output the message by voice from a voice output unit. Alternatively, the notification unit can transmit e-mail including the message to a prescribed e-mail account.

According to this aspect, since the expiration of the certificate can be notified promptly to the user, a management of the certificate can be facilitated and reliability of e-mail improves.

According to another aspect of the present invention, the e-mail communication device further includes an update accepting unit and an updating unit. The update accepting unit accepts a new certificate. The updating unit stores the new certificate accepted by the update accepting unit into the storage unit and updates the certificate.

In the above-described e-mail communication device, when the detecting unit detects the expiration of the certificate, until the updating unit updates the certificate, the control unit can control the transmission unit to suspend the transmission of the e-mail. According to this aspect, e-mail is not transmitted by using an invalid certificate, and e-mail is transmitted by attaching a valid certificate. As a result, reliability of e-mail improves.

In the above-described e-mail communication device, when the detecting unit detects the expiration of the certificate, the control unit can control the transmission unit to transmit the e-mail without the digital signature. According to this aspect, e-mail is not transmitted by using an invalid certificate. As a result, reliability of e-mail improves.

According to another aspect of the present invention, the e-mail communication device also includes a reservation accepting unit which accepts a transmission reservation time of the e-mail. The detecting unit can detect an expiration of the certificate at the transmission reservation time. According to this aspect, when reserving transmission of the e-mail, the expiration of the certificate at the transmission reservation time can also be detected. As a result, reliability of e-mail improves.

In the above-described e-mail communication device, when the detecting unit detects the expiration of the certificate at the transmission reservation time, the reservation accepting unit can refuse to accept the transmission reservation time. According to this aspect, when the transmission of the e-mail is reserved, the expiration of the certificate at the transmission reservation time does not generate. As a result, reliability of e-mail improves.

Further, any combinations of the above-described constituent elements and the conversions of the expression of the present invention between a method, a device, a system, a recording medium, a computer program or the like are also effective as a preferred embodiment of the present invention.

The present invention provides a highly reliable e-mail communication device which can periodically monitor validity of a certificate of the e-mail communication device. The present invention also provides a highly reliable e-mail communication device which can detect an expiration of a certificate of the e-mail communication device and control transmission of e-mail.

### BRIEF DESCRIPTION OF THE DRAWINGS

FIG. 1 is a functional block diagram illustrating a configuration of an e-mail communication device according to first and second preferred embodiments of the present invention.

FIG. 2 illustrates an example of a structure of a certificate according to the first and the second preferred embodiments of the present invention.

FIG. 3 is a flowchart illustrating an example of an operation of the e-mail communication device of FIG. 1.

FIG. 4 is a flowchart illustrating an example of an operation carried out when transmitting e-mail by a transmission reservation job of the e-mail communication device of FIG. 1.

FIG. 5 is a functional block diagram illustrating a configuration of a reservation accepting unit of the e-mail communication device according to the second preferred embodiment of the present invention.

FIG. 6 is a functional block diagram illustrating an e-mail communication device according to a third preferred embodiment of the present invention.

FIG. 7 illustrates an example of a structure of a certificate according to the third embodiment of the present invention.

FIG. 8 is a flowchart illustrating an example of an operation carried out for monitoring validity of the certificate of the e-mail communication device according to the third embodiment of the present invention.

### DETAILED DESCRIPTION OF PREFERRED EMBODIMENTS

(First Preferred Embodiment) With reference to the drawings, a description will be made of a first preferred embodiment of the present invention. In all of the drawings, like numerals are applied to like constituent elements, and a description is omitted as appropriate.

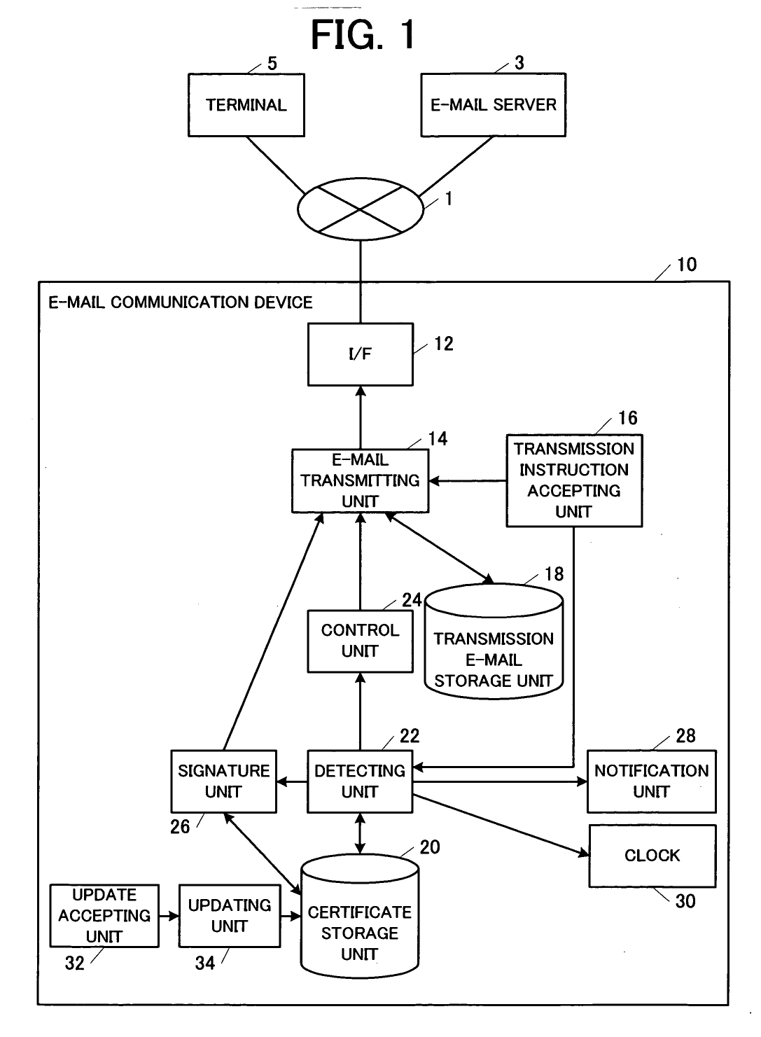

FIG. 1 is a functional block diagram illustrating a configuration of an e-mail communication device according to a first preferred embodiment of the present invention. An e-mail communication device 10 of the first preferred embodiment includes a certificate storage unit 20, a signature unit 26, a transmission unit, a transmission instruction accepting unit 16, a detecting unit 22 and a control unit 24. The certificate storage unit 20 stores a certificate of the e-mail communication device 10 including an effective period. The signature unit 26 adds a digital signature to e-mail by using the certificate. The transmission unit includes an e-mail transmitting unit 14 and an interface unit 12, and transmits the e-mail. The transmission instruction accepting unit 16 accepts a transmission instruction of the e-mail. When the transmission instruction accepting unit 16 accepts the transmission instruction, the detecting unit 22 detects an expiration of the effective period of the certificate. When the detecting unit 22 detects an expiration of the certificate, the control unit 24 controls the transmission unit.

For example, the e-mail communication device 10 is included in a terminal device (not illustrated) connected to a network 1, such as the Internet and a Local Area Network (LAN). The e-mail communication device 10 establishes a connection with an e-mail server 3 through the network 1. The e-mail communication device 10 transmits and receives e-mail to and from a plurality of terminals 5 (in FIG. 1, only one terminal 5 is illustrated) on the network 1. For example, the terminal 5 may comprise a personal computer, a workstation, an Internet facsimile machine, a Multi Functional Peripheral (MFP), a Personal Digital Assistance (PDA), a cellular phone or a Personal Handyphone System (PHS). In FIG. 1, a configuration of a part unrelated to the subject matter of the present invention is omitted. For example, an e-mail receiving unit, a received e-mail storage unit and an e-mail editing unit or the like of an e-mail communication device are not illustrated in FIG. 1.

Each constituent element of the e-mail communication device 10 is realized by any combination of hardware and software primarily by a Central Processing Unit (CPU) of any computer, a memory, a program which realizes the constituent elements illustrated in FIG. 1 loaded to the memory, a storage unit, such as a hard disk drive which stores the program, and an interface for establishing a connection with a network. It is understood by those skilled in the art that various changes and modifications can be made for methods and devices for realizing each of the constituent elements. Each of the drawings to be described hereinafter shows blocks representing units of function, instead of units of hardware.

As illustrated in FIG. 1, the e-mail communication device 10 includes the interface unit 12 (in the drawing, “I/F”), the e-mail transmitting unit 14, the transmission instruction accepting unit 16, a transmission e-mail storage unit 18, a certificate storage unit 20, the detecting unit 22, the control unit 24, the signature unit 26, a notification unit 28, a clock 30, an update accepting unit 32 and an updating unit 34.

The interface unit 12 carries out communication with the e-mail server 3 on the network 1. The interface unit 12 can establish a connection with the network 1 by either wireless communication or cable communication. The e-mail transmitting unit 14 transmits e-mail to the e-mail server 3 on the network 1 via the interface unit 12. The e-mail transmitted to the e-mail server 3 is received by the terminal 5 having an account of a destination of the e-mail. Further, the terminal 5 receives the e-mail by accessing to the e-mail server 3.

A user carries a transmission instruction of the e-mail by operating an operation unit (not illustrated). The transmission instruction accepting unit 16 accepts the transmission instruction carried out by the user. For example, the transmission instruction accepting unit 16 accepts a transmission instruction input by operating a transmission instruction icon displayed on a screen by a mouse (not illustrated) or by pressing an operation key. Alternatively, when a transmission reservation of the e-mail is carried out, as described hereinafter, in case of a transmission job reservation, the transmission instruction accepting unit 16 can accept a transmission instruction when a reservation time has been reached. Further, the transmission instruction accepting unit 16 refers to the clock 30 to acquire a present time. However, a control line is omitted in FIG. 1. The transmission instruction accepting unit 16 also accepts an instruction of whether or not to add a signature to the e-mail.

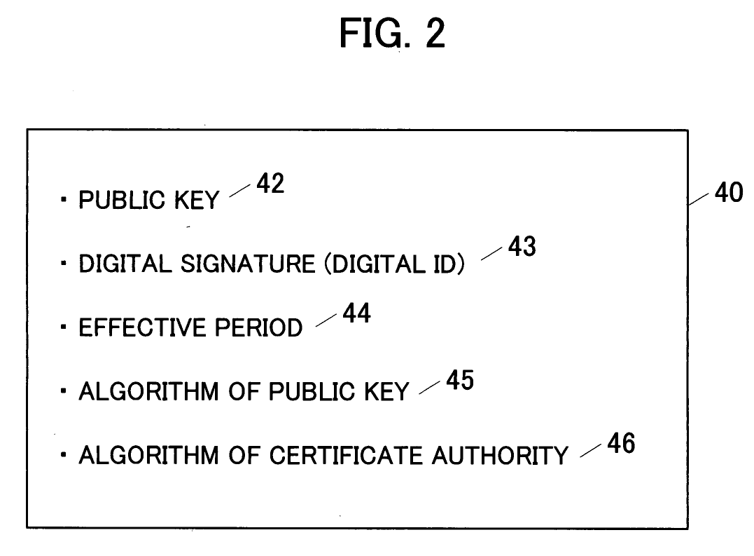

The transmission e-mail storage unit 18 stores transmission e-mail edited by an e-mail editing unit (not illustrated). The e-mail transmitting unit 14 transmits the e-mail stored in the transmission e-mail storage unit 18. The certificate storage unit 20 stores a certificate of the e-mail communication device 10 itself. The certificate of the e-mail communication device 10 itself is a certificate issued from a trustable certificate authority (not illustrated) used for a digital signature. FIG. 2 illustrates an example of a structure of the certificate according to the first preferred embodiment of the present invention. A certificate 40 includes certificate information, such as a public key 42, a digital signature 43, an effective period 44, an algorithm of a public key 45 and an algorithm of a certificate authority 46.

Referring to FIG. 1 again, when the transmission instruction accepting unit 16 accepts a transmission instruction, the detecting unit 22 detects an expiration of the effective period 44 of the certificate 40 of FIG. 2. The detecting unit 22 accesses to the clock 30 and acquires a present time. The detecting unit 22 confirms whether or not the present time has not lapsed the effective period 44.

When the detecting unit 22 detects an expiration of the certificate 40, the control unit 24 controls the e-mail transmitting unit 14. As a processing carried out at the expiration of the certificate 40, for example, until the updating unit 34 updates the certificate 40, the control unit 24 controls the e-mail transmitting unit 14 to suspend the transmission of the e-mail. Alternatively, the control unit 24 controls the e-mail transmitting unit 14 to transmit the e-mail without a digital signature.

The signature unit 26 adds a digital signature to the e-mail by using the certificate 40. When the detecting unit 22 detects the expiration of the certificate 40, the notification unit 28 notifies the user. For example, the notification unit 28 displays a message, such as “Effective period of certificate has expired” on a display unit (not illustrated), or outputs the message by voice from a voice output unit (not illustrated). Alternatively, the notification unit 28 may transmit e-mail including the message to a prescribed e-mail account.

The clock 30 clocks a present time. The update accepting unit 32 accepts a new certificate. The new certificate is a certificate issued from the certificate authority, for example. The update accepting unit 32 receives the new certificate via the network 1. Alternatively, the new certificate is a certificate issued from a certificate authority located inside the e-mail communication device 10. The updating unit 34 stores the new certificate accepted by the update accepting unit 32 into the certificate storage unit 20 and updates the certificate 40.

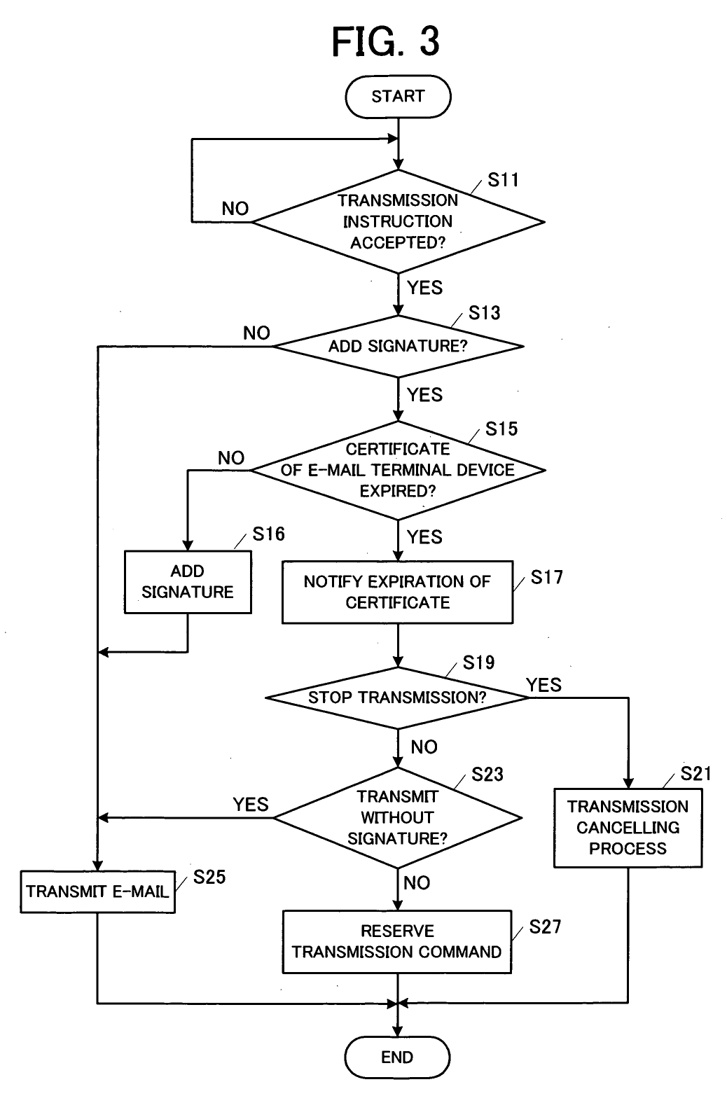

A description will be made of an operation carried out by the e-mail communication device 10. FIG. 3 is a flowchart illustrating an example of an operation carried out by the e-mail communication device 10 according to the first preferred embodiment of the present invention. A description will be made with reference to FIG. 1 through FIG. 3.

First, when the transmission instruction accepting unit 16 accepts a transmission instruction of e-mail (step S11: YES) and accepts an instruction for adding a signature (step S13: YES), the detecting unit 22 confirms the effective period 44 of the certificate 40 of the e-mail communication device 10 (step S15). When certificate 40 is expired (step S15: YES), the notification unit 28 notifies the expiration of the certificate 40 (step S17). Next, when the transmission instruction accepting unit 16 accepts a transmission stop instruction (step S19: YES), the control unit 24 instructs the e-mail transmitting unit 14 to cancel the transmission, and the e-mail transmitting unit 14 cancels the transmission of the e-mail (step S21).

When the transmission instruction accepting unit 16 does not accept an instruction for adding a signature (step S13: NO), the control unit 24 controls the e-mail transmitting unit 14 to transmit the e-mail stored in the transmission e-mail storage unit 18 via the interface unit 12 (step S25). When the detecting unit 22 determines that the effective period 44 of the certificate 40 of the e-mail communication device 10 has not expired (step S15: NO), the signature unit 26 adds a digital signature to the e-mail by using the certificate 40 stored in the certificate storage unit 20, and stores the e-mail into the transmission e-mail storage unit 18 (step S16). Next, the control unit 24 controls the e-mail transmitting unit 14 to transmit the e-mail stored in the transmission e-mail storage unit 18 via the interface unit 12 (step S25).

When the transmission instruction accepting unit 16 does not accept a transmission stop instruction (step S19: NO), the transmission instruction accepting unit 16 inquires the user as to whether or not to transmit e-mail without a signature (step S23) When the transmission instruction accepting unit 16 accepts a transmission instruction instructing to transmit the e-mail without a signature (step S23: YES), the control unit 24 controls the e-mail transmitting unit 14 to transmit the e-mail stored in the transmission e-mail storage unit 18 without a signature (step S25). When the transmission instruction accepting unit 16 accepts a transmission instruction instructing to transmit the e-mail with a signature (step S23: NO), the control unit 24 suspends the transmission of the e-mail. The control unit 24 reserves a transmission command at a prescribed reservation time (step S27). The reservation time is accepted by the transmission instruction accepting unit 16.

Further, the transmission of the e-mail reserved with a transmission command is suspended until the certificate is updated by the updating unit 34. A description will be given later of the transmission of the e-mail which has been reserved to be transmitted.

As described above, according to the e-mail communication device 10 of the first preferred embodiment of the present invention, by detecting an expiration of the certificate of the e-mail communication device 10, the validity of the certificate is confirmed. Then, a digital signature is added to the e-mail and the e-mail is transmitted. As a result, reliability of the e-mail improves. In addition, the expiration of the certificate is notified to the user, and the e-mail communication device 10 can accept a new certificate. As a result, a management of the certificate is facilitated.

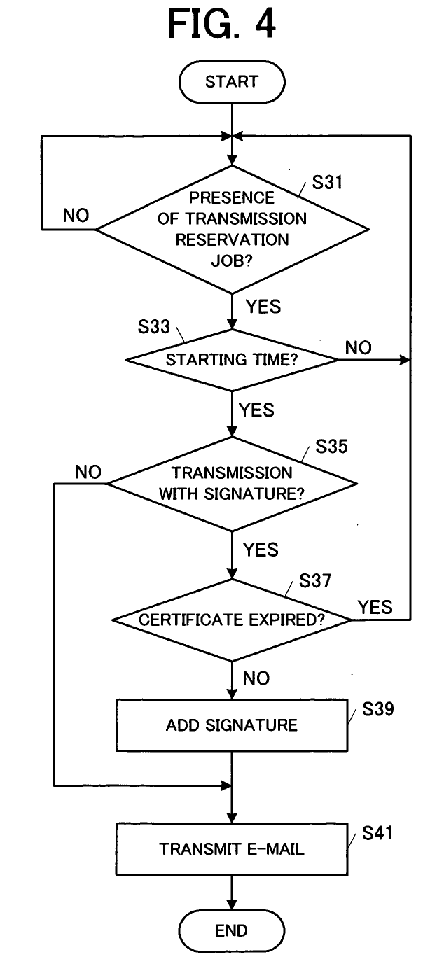

Next, a description will be made of an operation carried out when transmitting e-mail by a transmission reservation job. FIG. 4 is a flowchart illustrating an example of an operation carried out when transmitting e-mail by the transmission reservation job of the e-mail communication device 10 according to the first preferred embodiment of the present invention. A description will be made with reference to FIG. 1 through FIG. 4.

First, the transmission instruction accepting unit 16 monitors a presence or an absence of a transmission reservation job (step S31). In case of a presence of a transmission reservation job (step S31: YES), the transmission instruction accepting unit 16 monitors whether or not a reserved starting time has been reached (step S33). When the reserved starting time has been reached (step S33: YES), a determination is made as to whether or not the transmission instruction accepting unit 16 has accepted an instruction for adding a signature (step S35). When the instruction for adding the signature has not been accepted (step S35: NO), the control unit 24 controls the e-mail transmitting unit 14 to transmit the e-mail stored in the transmission e-mail storage unit 18 without a signature (step S41). When the instruction for adding the signature has been accepted (step S35: YES), the detecting unit 22 confirms the effective period 44 of the certificate 40 of the e-mail communication device 10 (step S37). When the certificate 40 has been expired (step S37: YES), the process returns to step S31. In this case, the control unit 24 delays the reservation time of the transmission reservation job for only a prescribed period of time. The transmission instruction accepting unit 16 accepts a new reservation time.

When the certificate 40 has not been expired (step S37: NO), the signature unit 26 adds a digital signature to the e-mail by using the certificate 40 stored in the certificate storage unit 20, and stores the e-mail into the transmission e-mail storage unit 18 (step S39). Next, the control unit 24 controls the e-mail transmitting unit 14 to transmit the e-mail stored in the transmission e-mail storage unit 18 with the signature (step S41)

As described above, according to the e-mail communication device 10 of the first preferred embodiment of the present invention, a transmission reservation can be made until the expired certificate is updated. Therefore, e-mail is not transmitted by using an expired certificate, and the e-mail can be transmitted by attaching an effective certificate. As a result, reliability of the e-mail improves.

The first preferred embodiment of the present invention has been described with reference to the drawings. The above-described first preferred embodiment is just one example of the present invention. Other variations may be adopted. For example, in the above-described first preferred embodiment, at step S23 of FIG. 3, the transmission instruction accepting unit 16 inquires the user as to whether or not to transmit the e-mail without a signature. However, the present invention is not limited to this example. For example, a registration unit (not illustrated) may be provided to previously store a designation of whether or not to transmit e-mail without a signature when the certificate is expired. At step S23, a determination may be carried out as to whether or not to transmit e-mail without a signature in accordance with the registered designation.

After step S37 of FIG. 4, a determination may be carried out as to whether or not to transmit e-mail without a signature in accordance with the instruction registered in the registration unit. When the designation to transmit e-mail without a signature is registered, the process proceeds onto step S41 and the e-mail transmitting unit 14 transmits the e-mail stored in the transmission e-mail storage unit 18. When the designation not to transmit e-mail without a signature is registered, the process returns to step S31.

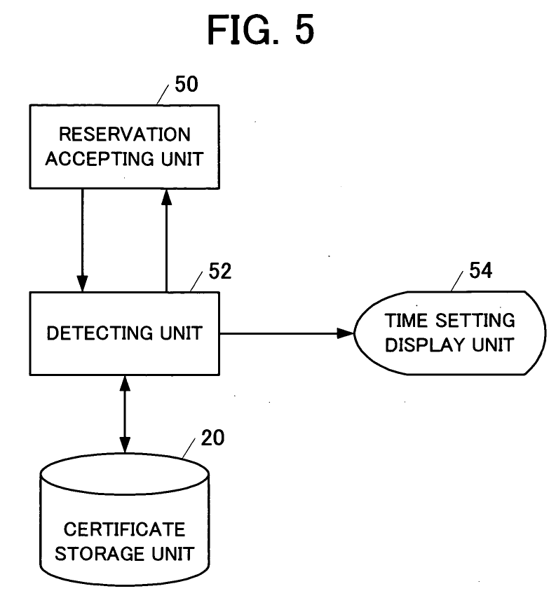

(Second Preferred Embodiment) FIG. 5 is a functional block diagram illustrating a configuration of a reservation accepting unit 50 according to a second preferred embodiment of the present invention. The second preferred embodiment differs from the first preferred embodiment regarding an aspect that when accepting a reservation time of transmission of e-mail, an expiration of a certificate at the reservation time can be detected. The e-mail communication device 10 according to the second preferred embodiment includes a reservation accepting unit 50 and a time setting display unit 54 in addition to the configuration of the first preferred embodiment. In place of the detecting unit 22, the e-mail communication device 10 may include a detecting unit 52.

The reservation accepting unit 50 accepts a transmission reservation time of e-mail. The accepted transmission reservation time is notified to the detecting unit 52. The detecting unit 52 includes the function of the detecting unit 22 of the first preferred embodiment. In addition, the detecting unit 52 detects an expiration of a certificate at the accepted transmission reservation time in accordance with the effective period of the certificate 40 of the certificate storage unit 20. The time setting display unit 54 is a Liquid Crystal Display (LCD) or a Cathode Ray Tube (CRT) monitor, for example. The time setting display unit 54 displays a screen for accepting the transmission reservation time. In addition, the time setting display unit 54 displays only a reservation time which has been confirmed by the detecting unit 52 as not being expired. When the detecting unit 52 detects an expiration of the certificate at the reservation time, the reservation accepting unit 50 refuses to accept a reservation time. The reservation time accepted by the reservation accepting unit 50 is notified to the transmission instruction accepting unit 16.

As described above, according to the e-mail communication device 10 of the second preferred embodiment of the present invention, when the transmission of the e-mail is reserved, an expiration of a certificate at a reservation time does not generate. As a result, reliability of the e-mail improves.

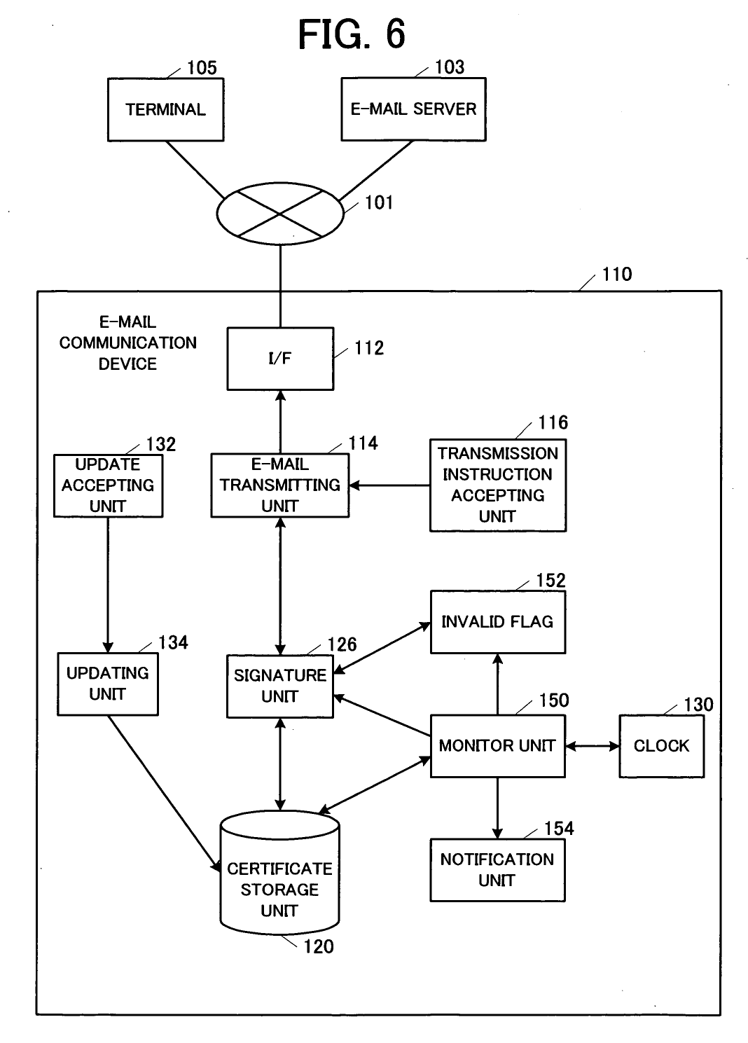

(Third Preferred Embodiment) FIG. 6 is a functional block diagram illustrating an e-mail communication device according to a third preferred embodiment of the present invention. An e-mail communication device 110 of the third preferred embodiment includes a certificate storage unit 120, a signature unit 126, a transmission unit (an interface unit 112 and an e-mail transmitting unit 114) and a monitor unit 150. The certificate storage unit 120 stores a certificate of the e-mail communication device 110. The signature unit 126 adds a digital signature to the e-mail by using the certificate. The transmission unit transmits e-mail. The monitor unit 150 monitors validity of the certificate.

For example, the e-mail communication device 110 is included in a terminal device (not illustrated) connected to a network 101, such as the Internet and the LAN. The e-mail communication device 110 establishes a connection with an e-mail server 103 via the network 101. The e-mail communication device 110 transmits and receives e-mail to and from a plurality of terminals 105 (in FIG. 6, only one terminal 105 is illustrated) on the network 101. For example, the terminal 105 may comprise a personal computer, a workstation, an Internet facsimile machine, an MFP, a PDA, a cellular phone or a PHS. In FIG. 6, a configuration of a part unrelated to the subject matter of the present invention is omitted. For example, an e-mail receiving unit, a received e-mail storage unit and an e-mail editing unit or the like of the e-mail communication device are not illustrated in FIG. 6.

Each constituent element of the e-mail communication device 110 is realized by any combination of hardware and software primarily by a CPU of any computer, a memory, a program which realizes the constituent elements illustrated in FIG. 6 loaded to the memory, a storage unit, such as a hard disk drive which stores the program, and an interface for establishing a connection with a network. It is understood by those skilled in the art that various changes and modifications can be made for methods and devices for realizing each of the constituent elements. Each of the drawings to be described hereinafter shows blocks representing units of function, instead of units of hardware.

As illustrated in FIG. 6, the e-mail communication device 110 includes the interface unit 112 (in the drawing, “I/F”), the e-mail transmitting unit 114, a transmission instruction accepting unit 116, a certificate storage unit 120, a signature unit 126, a clock 130, an update accepting unit 132, an updating unit 134, a monitor unit 150, an invalid flag 152 and a notification unit 154.

The interface unit 112 carries out communication with the e-mail server 103 on the network 101. The interface unit 12 can establish a connection with the network 101 by either wireless communication or cable communication. The e-mail transmitting unit 114 transmits e-mail to the e-mail server 103 on the network 101 via the interface unit 112. The e-mail transmitted to the e-mail server 103 is received by the terminal 105 having an account of a destination of the e-mail. Further, the terminal 105 receives the e-mail by accessing to the e-mail server 103.

A user carries out a transmission instruction of the e-mail by operating an operation unit (not illustrated). The transmission instruction accepting unit 116 accepts the transmission instruction carried out by the user. For example, the transmission instruction accepting unit 116 can accept a transmission instruction input by operating a transmission instruction icon displayed on a screen by a mouse (not illustrated) or by pressing an operation key. The e-mail transmitting unit 114 transmits e-mail instructed to be transmitted by the transmission instruction accepting unit 116. The transmission e-mail is edited by an e-mail editing unit (not illustrated) or the like and stored in an e-mail storage unit (not illustrated).

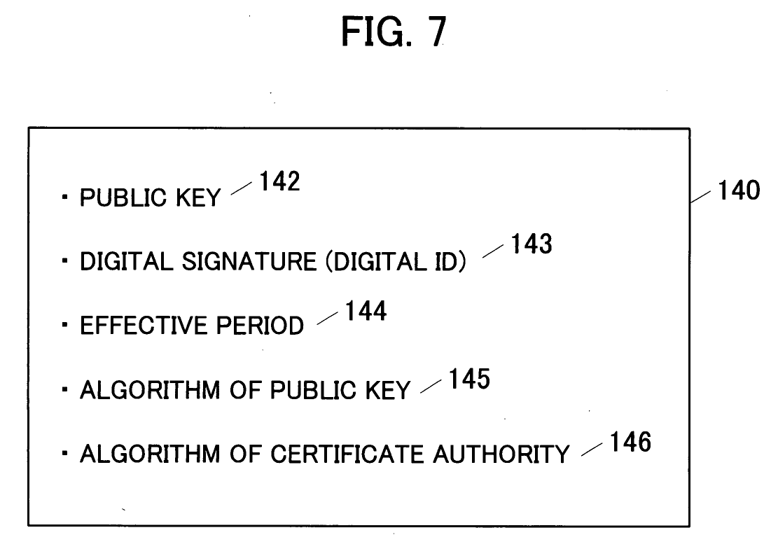

The certificate storage unit 120 stores a certificate of the e-mail communication device 110 itself. The certificate of the e-mail communication device 110 itself is a certificate issued from a trustable certificate authority (not illustrated) used for a digital signature. FIG. 7 illustrates an example of a structure of the certificate according to the third preferred embodiment of the present invention. A certificate 140 includes certificate information, such as a public key 142, a digital signature 143, an effective period 144, an algorithm of a public key 145 and an algorithm of a certificate authority 146.

Referring to FIG. 6 again, the signature unit 126 adds a digital signature to e-mail by using the certificate 140. As to be described later, the signature unit 126 refers to the invalid flag 152, and only when the invalid flag 152 is set off, the signature unit 126 adds a signature to the e-mail. The clock 130 clocks a present time. The update accepting unit 132 accepts a new certificate. For example, the new certificate is a certificate issued from a certificate authority. The update accepting unit 132 receives the new certificate via the network 101. Alternatively, the new certificate is a certificate issued from a certificate authority provided in the e-mail communication device 110 itself. The updating unit 134 stores the new certificate accepted by the update accepting unit 132 into the certificate storage unit 120 and updates the certificate 140.

The monitor unit 150 monitors validity of the certificate 140 stored in the certificate storage unit 120. For example, the validity of the certificate is whether or not an effective period of the certificate has expired, whether or not a remaining number of days of the effective period is a prescribed warning number of days or less, or whether or not the certificate has not become invalid. The monitor unit 150 monitors periodically, at a prescribed time, or as appropriate according to a request from a user.

A description will be made of a case where the monitor unit 150 determines the validity of the certificate 140 of FIG. 7 according to whether or not the effective period 144 has expired. The monitor unit 150 compares the effective period 144 with the present time obtained from the clock 130, and calculates a remaining number of days of the effective period 144 of the certificate 140. The monitor unit 150 monitors whether or not the remaining number of days is exceeding the prescribed warning number of days. That is, while the remaining number of days until the expiration of the effective period 144 is exceeding the prescribed warning number of days, the monitor unit 150 determines that the certificate 140 is valid and sets off the invalid flag 152. When the remaining number of days becomes less than the prescribed warning number of days, the monitor unit 150 determines that the certificate 140 has expired and sets on the invalid flag 152.

When the monitor unit 150 determines that the certificate 140 is invalid, the notification unit 154 notifies the user. For example, the notification unit 154 displays a message on a display unit or outputs the message by voice from a voice output unit. Alternatively, the notification unit 154 may transmit e-mail including the message to a prescribed e-mail account. For example, the message is “Effective period of certificate has expired”, “Effective period of certificate will expire shortly” or “Certificate is invalid”.

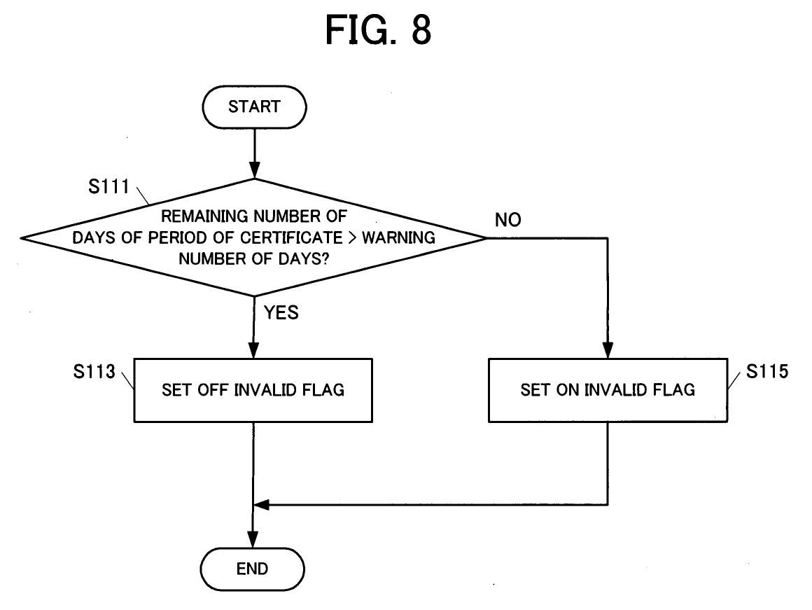

Next, a description will be made of an operation of the e-mail communication device 110. FIG. 8 is a flowchart illustrating an example of an operation carried out for monitoring validity of the certificate 140 of the e-mail communication device 110 according to the third preferred embodiment of the present invention. A description will be made with reference to FIG. 6 through FIG. 8.

First, the monitor unit 150 monitors whether or not the remaining number of days of the effective period 144 of the certificate 140 of FIG. 7 is exceeding the prescribed warning number of days (step S111). While the remaining number of days is exceeding the warning number of days (step S111: YES), the monitor unit 150 sets off the invalid flag 152 (Step S113). When the remaining number of days has becomes less than the warning number of days (step S111: NO), the monitor unit 150 sets on the invalid flag 152 (step S115). The notification unit 154 notifies the expiration of the certificate 140 to the user.

As described above, when the expiration of the effective period 144 of the certificate 140 has been detected, the user is notified and the signature unit 126 adds a signature to the e-mail by using only a valid certificate 140. Thus, e-mail is not transmitted by using an invalid certificate and reliability of the e-mail improves.

The third preferred embodiment of the present invention has been described with reference to the drawings. However, the above-described third preferred embodiment is just one example of the present invention. The present invention may adopt other various variations.

For example, in the above-described third preferred embodiment, the validity of the certificate is confirmed in accordance with the effective period of the certificate. However, the present invention shall not be limited to this example. For example, a confirmation can be made in accordance with validity of the certificate, such as whether or not the certificate has not become invalid within the effective period. In case of such an example, the e-mail communication device 110 includes an inquiry unit (not illustrated) which inquires the certificate authority as to the information on the validity of the certificate. For example, the inquiry unit may inquire the certificate authority as to invalidity of the certificate by using a prescribed protocol. Alternatively, the inquiry unit may request an invalidity list, refer to the acquired invalidity list and confirm a presence or an absence of invalidity of the certificate.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the invention.

What is claimed is:

1. An e-mail communication device, comprising:
a storage unit which stores a certificate of the e-mail communication device including an effective period;
a signature unit which adds a digital signature to e-mail by using the certificate;
a transmission unit which transmits the e-mail;
an accepting unit which accepts a transmission instruction of the e-mail;
a detecting unit which detects an expiration of the effective period of the certificate when the accepting unit accepts the transmission instruction; and
a notification unit which notifies a user when the detecting unit detects the expiration.

2. An e-mail communication device, comprising:
a storage unit which stores a certificate of the e-mail communication device including an effective period;
a signature unit which adds a digital signature to e-mail by using the certificate;
a transmission unit which transmits the e-mail;
an accepting unit which accepts a transmission instruction of the e-mail;
a detecting unit which detects an expiration of the effective period of the certificate when the accepting unit accepts the transmission instruction;
an update accepting unit which accepts a new certificate; and
an updating unit which stores the new certificate accepted by the update accepting unit into the storage unit and updates the certificate.

3. The e-mail communication device according to claim 1, wherein when the detecting unit detects the expiration, until the updating unit updates the certificate, the control unit controls to suspend transmission of the e-mail by the transmission unit.

4. The e-mail communication device according to claim 2, wherein when the detecting unit detects the expiration, until the updating unit updates the certificate, the control unit controls to suspend transmission of the e-mail by the transmission unit.

5. The e-mail communication device according to claim 1, wherein when the detecting unit detects the expiration, the control unit controls the transmission unit to transmit the e-mail without adding the digital signature.

6. The e-mail communication device according to claim 2, wherein when the detecting unit detects the expiration, the control unit controls the transmission unit to transmit the e-mail without adding the digital signature.

7. The e-mail communication device according to claim 1, wherein when the detecting unit detects the expiration of the certificate at a transmission reservation time, a reservation accepting unit refuses to accept the transmission reservation time.

8. The e-mail communication device according to claim 2, wherein when the detecting unit detects the expiration of the certificate at a transmission reservation time, a reservation accepting unit refuses to accept the transmission reservation time.

9. An e-mail communication device, comprising:
a storage unit which stores a certificate of the e-mail communication device;
a signature unit which adds a digital signature to e-mail by using the certificate;
a transmission unit which transmits the e-mail; and
a monitor unit which monitors validity of the certificate.

10. The e-mail communication device according to claim 9, further comprising a notification unit which notifies a user when the monitor unit determines that the certificate is invalid.

11. The e-mail communication device according to claim 9, further comprising:
an update accepting unit which accepts a new certificate; and
an updating unit which stores the new certificate accepted by the update accepting unit into the storage unit and updates the certificate.

12. The e-mail communication device according to claim 10, further comprising:
an update accepting unit which accepts a new certificate; and
an updating unit which stores the new certificate accepted by the update accepting unit into the storage unit and updates the certificate.

13. The e-mail communication device according to claim 11, wherein when the monitor unit determines that the certificate is invalid, until the updating unit updates the certificate, the transmission unit suspends transmission of the e-mail.

14. The e-mail communication device according to claim 12, wherein when the monitor unit determines that the certificate is invalid, until the updating unit updates the certificate, the transmission unit suspends transmission of the e-mail.

15. The e-mail communication device according to claim 9, wherein when the monitor unit determines that the certificate is invalid, the transmission unit transmits the e-mail without the digital signature.

16. The e-mail communication device according to claim 10, wherein when the monitor unit determines that the certificate is invalid, the transmission unit transmits the e-mail without the digital signature.
